(19) United States
(12) Patent Application Publication
(10) Pub. No.: US 2009/0058259 A1
(43) Pub. Date: Mar. 5, 2009

(54) QUENCHED PHOSPHOR DISPLAYS WITH PIXEL AMPLIFICATION

(75) Inventor: John L. Janning, Bellbrook, OH (US)

Correspondence Address: DYKEMA GOSSETT PLLC, 39577 WOODWARD AVENUE, SUITE 300, BLOOMFIELD HILLS, MI, 48304-5086, US

(73) Assignee: St. Clair Intellectual Property Consultants, Inc., Grosse Pointe, MI (US)

(21) Appl. No.: 12/248,615

(22) Filed: Oct. 9, 2008

Related U.S. Application Data
(63) Continuation-in-part of application No. 11/306,974, filed on Jan. 18, 2006.
(60) Provisional application No. 60/668,314, filed on Apr. 5, 2005.

(51) Int. Cl. H01J 63/04

(52) U.S. Cl. 313/497

(57) ABSTRACT

Displays are described comprising electrically quenched phosphor pixels, in which light emissions by a phosphor pixel are inhibited by application of an electric field. Such pixels may be excited by UV and de-excited by applying a voltage to control the display. In an embodiment, a pixel amplifier structure may be included and added to the output of a quenched phosphor display.

### CROSS-REFERENCE TO RELATED APPLICATIONS

This application is a continuation-in-part application and claims priority to pending U.S. patent application Ser. No. 11/306,974, filed Jan. 18, 2006, entitled “Quenched Phosphor Displays,” which claims priority to U.S. Provisional Application Ser. No. 60/668,314, filed Apr. 5, 2005, entitled “Quenched Phosphor Display,” both of which are hereby incorporated by reference in their entirety.

### BACKGROUND

It is known that the application of an AC or DC potential can quench or inhibit fluorescence of phosphors, e.g., of the ZnS group. The phenomenon has been observed for electric fields applied both during and after phosphor excitation with ultraviolet (UV) light. See, e.g., Daniel, P. J., et al., “Control of Luminescence by Charge Extraction,” Physical Review, Volume 111, Number 5, Sep. 1, 1958, pages 1240-1244; and Kallmann, H., et al., “De-Excitation of ZnS and ZnCdS Phosphors by Electric Fields,” Physical Review, Volume 109, Number 3, Feb. 1, 1958, pages 721-729.

Luminescent light emissions from phosphors have been widely used in displays of various types, including CRTs, ELDs, FEDs and plasma displays for home and business use. Such displays have generally operated by controlled excitation of the phosphors, either by applied radiation or electron bombardment, creating a pattern on a phosphor pixel array.

### SUMMARY

Displays are described comprising electrically quenched phosphor pixels, in which light emissions by a phosphor pixel are inhibited by application of an electric field. Such pixels may be excited by UV and de-excited by applying a voltage to control the display. Moreover, for some embodiments, additional layers or structure may be included to provide for increased amplification.

Advantages, variations and other features of the invention will become apparent from the drawings, the further description of examples and the claims to follow.

### BRIEF DESCRIPTION OF THE DRAWINGS

FIG. 1a shows a sectional side view of an exemplary pixel cell structure in which a pixel phosphor is excited from behind by application of UV radiation.

FIG. 1b shows the exemplary pixel cell structure of FIG. 1a in which the fluorescence of the pixel phosphor is quenched by an applied electric field.

FIG. 2 is an enlarged sectional view of the cell structure of FIGS. 1a and 1b.

FIG. 3 is a cross-sectional representation of a pixel amplifier for a quenched phosphor display according to an embodiment of the invention.

### DETAILED DESCRIPTION

Exemplary displays are described where radiation excitable phosphors are used and quenched in selected areas or pixels. Quenching of a UV excited phosphor may be accomplished by applying an electric field across the excited phosphor. Preferably, the electric field is sourced by direct current (DC) voltage although alternating current (AC) voltage could be used in selected applications, e.g., to inhibit excitation “recovery”.

It is known that certain phosphors—such as ZnS compounds, for example—under UV excitation, can be quenched (or de-excited) by thermal means and/or by an electric field. The use of these phenomena for construction of displays will be further described.

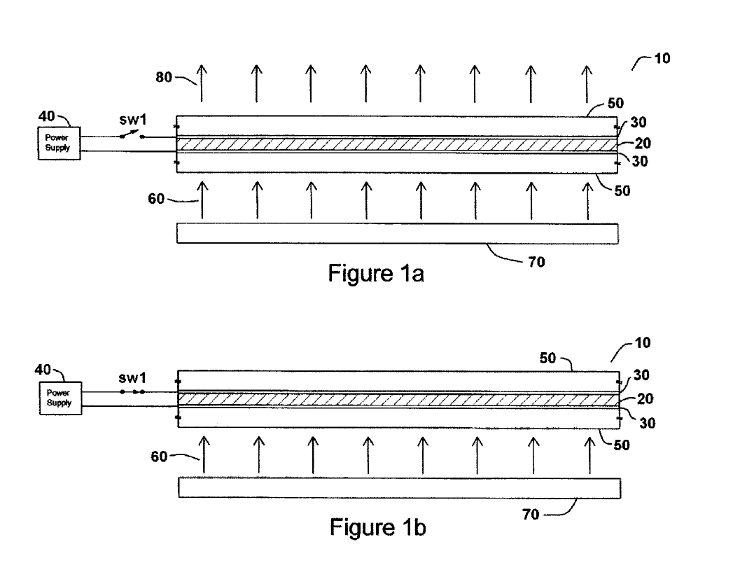

FIG. 1a and FIG. 1b depict an exemplary thin film “electroluminescent type” cell structure configuration 10 for a phosphor-based pixel in a display. The illustrated construction 10 is similar to an electroluminescent (EL) cell but the operation is different.

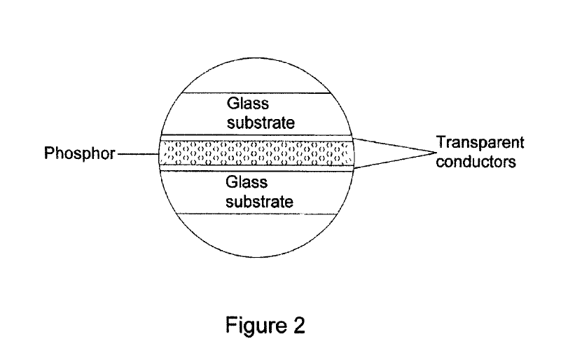

The illustrated phosphor 20 is disposed between transparent conductive coatings 30 which serve as electrodes and apply an electronic quenching field sourced by a power supply 40 upon closure of a switch SW1. The phosphor 20 and the conductive coatings 30 are in turn disposed between glass plates or substrates 50 as shown in FIGS. 1a, 1b and 2. It is noted that for certain embodiments, the associated phosphors may be organic or inorganic. Ultraviolet (UV) radiation 60 from a UV light source 70 such as an LED impinging on the phosphor excites the phosphor 20 to emit light 80 of its own frequency.

As shown in FIGS. 1a and 1b, UV light 60 is projected at the phosphor 20 from behind through the lower glass plate substrate 50. Resulting fluorescence or light emissions 80 by the excited phosphor 20 are emitted through the upper transparent conductive coating 30 and glass plate substrate 50 when the switch SW1 is open as shown in FIG. 1a. Closure of switch SW1 quenches the phosphor 20, inhibiting light emissions to control the display as shown in FIG. 1b. A voltage is applied across the phosphor pixel cell structure 10, with the closing of switch SW1, inhibiting the applied UV light 60 from exciting and thus “quenching” the phosphor 20.

Note that in FIG. 1a, the UV light 60 excites the phosphor 20 where the light exciting the phosphor 20 is generally the ‘converted’ light frequency from the phosphor 20. As shown, the UV light 60 can excite the phosphor 20 to emit photons of the phosphor's inherent frequency without passing through the excited phosphor 20.

Different phosphors emit different light wavelengths—even though excited by the same UV source. Different phosphors may accordingly be used to construct different color displays, or full color displays, as in other phosphor-based display technologies.

FIGS. 1a, 1b and 2 illustrate an exemplary cell structure 10 for one pixel. Many pixels could be constructed in a matrix as in other types of displays to display a picture for a flat panel television, laptop computer, cell phone, gas pump display or the like. To differentiate between pixels, areas between the pixels can be darkened, or not have any phosphor deposited, or have the phosphor removed selectively, using well known methods.

Normally, in a light emitting display, the screen is dark and selected areas or pixels are lit to display a picture or data. In a display using electrically quenched phosphor pixels, the entire screen can be “lit” (excited by UV) and selected areas or pixels are quenched to inhibit or “turn off the light” to create the pattern. Phosphors excited by UV radiation can be quite bright. The common fluorescent light is a good example of this.

While FIGS. 1a and 1b depict the use of an ultraviolet light source to excite the phosphors, the entire cell could be constructed inside of a “fluorescent type” light. In such a construction, a plasma or ionized gas emitting ultraviolet radiation would excite the phosphors internally. Quenching of the phosphors in this type of display cell could yield very high contrast ratios. Other potential sources of UV light include LEDs as is well known.

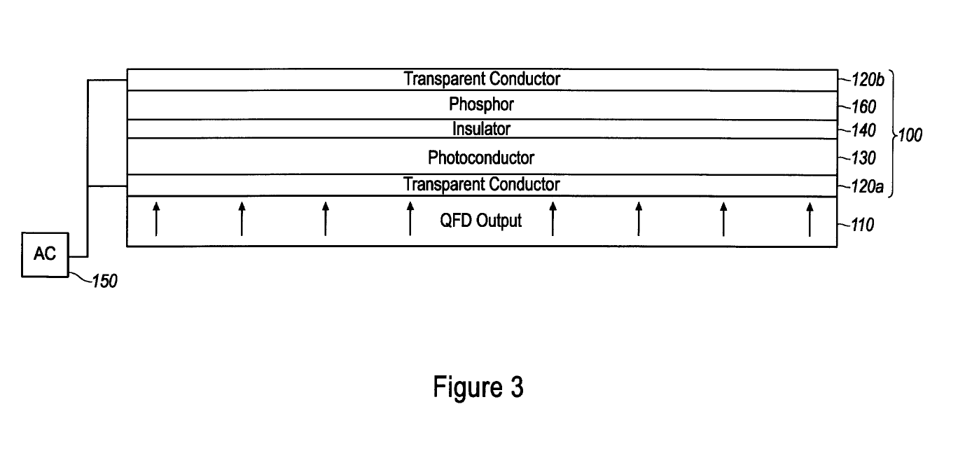

FIG. 3 illustrates an exemplary pixel amplifier 100 for a quenched phosphor display. Such an amplifier, or variations thereof (which would be contemplated by those of skill in the art in view of the present teachings), may be added to the output 110 of a quenched phosphor display. For example, without limitation, light output from associated pixels may be amplified and integrated. The term “integrated” is meant to mean that the pixels are not required to be defined by the X and Y electrodes, but rather may be spread out slightly to provide a more realistic look to the picture or other output.

With an embodiment of an amplifier 100, which may be in direct physical contact with a quenched phosphor display output 110, light/output from the quenched phosphor display can enter through a transparent conductor 120a and into a photoconductor 130, whereby the electrical resistance of the photoconductive material may decrease with light intensity. For example, without limitation, in an embodiment the photoconductor 130 may be comprised of cadmium sulphide or cadmium selenide. An insulating layer (e.g., a black insulating layer) 140 can keep light from the illuminated phosphor from “feeding back.” When an AC voltage 150 is applied to transparent conductor electrodes (e.g., associated with conductors 120a, 120b), the phosphor 160 will illuminate in intensity with respect to the resistance of the photoconductor as it is illuminated from the pixel output of the quenched phosphor display.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed:

1. A display comprising:
a plurality of phosphor pixels configured to provide an output, the phosphor pixels are configured to be electrically quenched, and an electric field is configured such that application of the electric field inhibits light emission from one or more phosphor pixels;
a pixel amplifier in operative communication with the output and configured to amplify the output provided by the phosphor pixels.

2. The display of claim 1, including an insulating layer configured to prevent light from the phosphor pixels from feedback.

3. The display of claim 1, wherein the pixel amplifier includes a pair of transparent conductors, a photoconductor, and a phosphor, the photoconductor and phosphor at least partially separated by an insulator.

4. The display of claim 3, wherein AC voltage is applied to the transparent conductors to illuminate the phosphor.

5. The display of claim 1, wherein the phosphor pixels are excited by UV light.

6. The display of claim 5, wherein a source of the UV light comprises an LED.

7. The display of claim 5, wherein a source of the UV light is excited plasma.

8. The display of claim 5, wherein the phosphor pixels are inside a fluorescent light.

9. The display of claim 1, wherein the electric field is a DC electric field.

10. The display of claim 1, wherein the electric field is an AC electric field.

11. The display of claim 1, wherein the phosphor pixels comprise ZnS.

12. The display of claim 1, wherein the pixels comprise thin film cell structures.

13. The display of claim 5, wherein the phosphor pixels comprise thin film cell structures and the UV light does not pass through the cell structures but excites the phosphor pixels to emit photons at the inherent frequency of the phosphor pixels.

14. The display of claim 1, wherein the phosphor pixels are provided in a matrix.

15. The display of claim 1, wherein the phosphor pixels are electrically quenched to turn off emitted light.

16. The display of claim 1, wherein darkened areas are provided between the phosphor pixels.

17. The display of claim 1, wherein areas between the phosphor pixels are devoid of phosphor.

18. The display of claim 1, wherein phosphor is selectively removed between said pixels.

19. The display of claim 1, wherein the phosphor pixels comprise a pixel cell constructed inside a fluorescent light.

20. The display of claim 19, wherein ionized gas emits UV radiation exciting the phosphor pixels.

21. The display of claim 19, wherein UV radiation is emitted inside the fluorescent light.

22. The display of claim 1, wherein the phosphor pixels are disposed between transparent conductive coatings.

23. The display of claim 22, wherein the electric field is created by an electric potential applied across said coatings.

24. The display of claim 22, wherein the phosphor pixels emit fluorescent light through a glass faceplate overlying one of the transparent conductive coatings.

25. The display of claim 22, wherein the phosphor pixels are excited by UV light emitted through a glass plate overlying one of the transparent conductive coatings.

26. The display of claim 22, wherein the phosphor pixels are disposed between glass substrates.

27. The display of claim 22, wherein the transparent conductive coatings and the phosphor pixels are disposed between a pair of glass substrates.

28. The display of claim 27, wherein the phosphor pixels emit fluorescent light through one of the glass substrates.

29. The display of claim 27, wherein the phosphor pixels are excited by UV light projected through another of the glass substrates.

30. The display of claim 1, wherein the phosphor pixels are excited by application of UV light through edge lighting of the display.

31. The display of claim 1, wherein the phosphor pixels are comprised of an inorganic material.

32. The display of claim 31, wherein fluorescence of inorganic phosphor pixels is excited by UV radiation and inhibited by the electric field.

33. A display comprising:
a phosphor display output;
a pixel amplifier configured for operative communication with the display output;
wherein the pixel amplifier includes a pair of transparent conductors, a photoconductor, and a phosphor, the photoconductor and phosphor at least partially separated by an insulator.

34. The display of claim 33, wherein the pixel amplifier is in direct physical contact with the display output.

35. The display of claim 33, wherein the electrical resistance of the photoconductor decreases with increased light intensity.

36. The display of claim 33, wherein the photoconductor includes vacuum deposited cadmium sulphide or cadmium selenide.

37. A display comprising:
a means for providing a phosphor display output, the means for providing an output including quenched phosphor pixels; and
a means for amplifying the phosphor display output including a phosphor and a photoconductor, the means for amplifying being in operative communication with the means for providing a phosphor display output;
wherein the means for amplifying is configured to receive a voltage and the photoconductor causes the phosphor to be illuminated from the phosphor display output.
